(19) United States
(12) Patent Application Publication
(10) Pub. No.: US 2023/0397592 A1
(43) Pub. Date: Dec. 14, 2023

(54) Fish Strike Indicator

(71) Applicant: Joshua Lesack, Salem, OH (US)

(72) Inventor: Joshua Lesack, Salem, OH (US)

(21) Appl. No.: 17/664,957

(22) Filed: Jun. 9, 2022

(51) Int. Cl. A01K 97/12; A01K 87/00; F16B 1/00

(52) U.S. Cl. CPC A01K 97/12; F16B 2001/0035; F16B 1/00; A01K 87/008

(57) ABSTRACT

An indicator assembly for use with a fishing rod and line for bottom fishing. The indicator assembly is comprised of an indicator body having a pair of opposed indicator couplers and a channel formed though the indicator body such that openings for the channel are perpendicular to the indicator couplers. The channel has a diameter greater than that of a second and third eyelet of the fishing rod such that the line positioned inside the eyelets and channel when pulled taught forms a straight line. A rod coupler is affixed to the fishing rod by way of a pair of holders and positioned ideally between the second and third eyelets of the fishing rod. The rod and indicator couplers are rare earth magnets of opposite poles, or ferrous magnets or combinations of magnets and magnetic materials. An indicator kit and a method of use are also described.

### CROSS-REFERENCE TO RELATED APPLICATIONS

NA

### STATEMENT REGARDING FEDERALLY SPONSORED RESEARCH OR DEVELOPMENT

NA

### NAMES OF THE PARTIES TO A JOINT RESEARCH AGREEMENT

NA

### INCORPORATION BY REFERENCE OF MATERIAL SUBMITTED ON A COMPACT DISC OR AS A TEXT FILE VIA THE EFS WEB SYSTEM

NA

### STATEMENT REGARDING PRIOR DISCLOSURES BY THE INVENTOR OR A JOINT INVENTOR

NA

### BACKGROUND OF THE INVENTION

### Field of the Invention

The present invention is in the field of rod fishing accessories. More particularly, the invention is a slip bobber strike indicator that can be permanently installed on the rod.

### Background Art

Fishing using a line and rod has been a favorite pastime for centuries. Use of the first fishing rods were recorded in China and Egypt as early as 2000 BC and fishing as an activity are common recurring symbols in Chinese paintings. While fishing requires little more than a hook, line, rod and bait, many fishers soon realize that bobbers greatly enhance the fishing experience. Bobbers are lightweight fishing indicator accessories with two main functions: 1) to position the hook and bait at an appropriate foraging depth according to fish species; and 2) to alert the fisher when a fish has taken the bait.

Currently, there are two main types of bobbers, fixed bobbers and slip bobbers. The fixed bobber is the classic red and white ball shaped bobber common in the United States, and typically clips onto the fishing line at a fixed position, thus limiting the depth at which the baited hook can travel below the water surface. It is most useful for fishing in shallow water where depth is 6 feet or less. The slip bobber is formed with a central through-hole and threaded onto the fishing line, after the terminal eyelet or tip top of the fishing rod, and before the hook. The slip bobber thus is able to slide along the length of the fishing line, thus a bobber stopper is used in conjunction with the slip bobber to limit travel along the fishing line and thus allow the fisher to “set” the depth of the hook in the water. Slip bobbers are more versatile than fixed bobbers as they can accommodate deep fishing greater than 6 feet below water surface for deep water or bottom fishing.

Despite the proven utility of bobbers, they have known drawbacks. The main issue is loss of the bobber. While fishing, either bobber type has a tendency to interfere with proper casting and can tangle the fishing line. When the fishing rod is stored, the bobber risks being lost or misplaced as neither bobber type is designed to be stored on the rod after placement thereon.

When the depth of the hook and bait is not an issue, particularly when fishing for bottom dwelling fish such as catfish and trout, another type of bobber, known as a strike indicator, has been created to work solely to indicate to the fisher that a fish has taken the bait. After casting, strike indicators are attached to the fishing line underneath the fishing pole between a pair of eyelets on the fishing pole and use clips, hooks or other means to attach to the fishing line. The strike indicator is positioned on the line and then pulled downwards so as to hang in spaced apart relationship with the fishing rod, creating a slack portion in the line. When a fish takes the bait and attempts to swim away, the strike indicator rises as the fishing line is pulled taught, repositioning the strike indicator adjacent the underside of the fishing rod.

Presently, many indicators feature additional electronic features that in addition to the change in line tension light up or chime to further alert the fisher. While clever, these electrical features are unnecessary and further complicate the bobber, including the need for expensive button batteries and protecting the indicator from moisture to avoid damaging the electrical features. The strike indicator also must be removed every time the fisher casts, to prevent the strike indicator from interfering with casting or tangling the fishing line. Since the strike indicator is constantly being put on and off the fishing line, the clips, hooks and other temporary fasteners are designed to facilitate the on/off activity and minimize damage to the fishing line and are not designed to facilitate casting. For storage purposes, these strike indicators must be removed after use, as their weight causes a loop in the fishing line increasing the chances of the line being damaged or tangled, and the indicator subsequently lost.

What is needed is a simple strike indicator that is easy to use, affordable, does not need batteries or moisture control, and can be permanently and securely installed on the fishing line during casting as well as for general storage of the rod when not in use.

### DISCLOSURE OF INVENTION

A strike indicator assembly for use with a fishing rod comprising an indicator body, a rod coupler, and a holder. The indicator body is typically spherical or cuboid and provided with a pair of opposed indicator couplers, each indicator coupler having an outer face, and a channel formed through the indicator body with openings perpendicular to the indicator couplers. The rod coupler is installed on the fishing rod by way of one or more holders. The rod coupler has an outermost surface that couples with the outer face of the indicator couplers. The couplers are rare earth or ferrite magnets of opposed polarities, or combinations of magnets and magnetic metal materials.

In a first aspect of the invention, the rod coupler is installed between a second eyelet and a third eyelet immediately below a tip of the fishing rod, and the channel of the indicator body is at least a same diameter as a height of both of the second and third eyelets.

In a second aspect of the invention, the indicator body is made at least in part of wood or plastic or other suitable lightweight material. In some embodiments, the indicator body is further comprised of at least one or more materials that are buoyant or fluorescent.

In a third aspect of the invention, the holder is an elastic material such as TPE that can be enlarged and slipped over the fishing rod and eyelets, a quantity of tape, or a pressure fitted clamp affixed directly to the fishing rod.

In yet a fourth aspect of the invention, the indicator assembly is provided as a kit including a tool used for installing the holder onto the fishing rod where the holder is an elastic material.

In a fifth aspect of the invention, a method of using an indicator assembly is comprised of the following steps: (1) attaching the indicator coupler to the rod coupler; (2) casting the fishing line; (3) decoupling the indicator coupler from the rod coupler; (4) creating a loop in the fishing line wherein the indicator body is positioned at a lowermost point in the loop and is in spaced apart relationship with the fishing rod; (5) waiting for a fish to strike at the bait on the hook attached to the fishing line; and (6) watching the indicator body rise towards the fishing rod and reattach to the rod coupler as the loop is eliminated from the fishing line by at least one of the striking fish swims away with the bait, a fisher reeling in the line, or both.

In yet a sixth aspect of the invention, the method is further comprised of the steps of installing the rod coupler to the fishing rod prior to the step of attaching the indicator body to the fishing rod, and the steps of threading the fishing line through the eyelet before the rod coupler, threading the fishing line through the attached indicator body, and threading the fishing line through the eyelet immediately after the rod coupler after the step of attaching the indicator body to the fishing rod.

### BRIEF DESCRIPTION OF THE DRAWINGS

The features and advantages of the invention will become apparent from a consideration of the subsequent detailed description presented in connection with accompanying drawings, in which:

FIG. 1 is a side elevation view of an improved strike indicator assembly shown affixed to a fishing rod between eyelets just below a tip of the fishing rod and prior to installation on a fishing line.

FIG. 2 is a side elevation view of an indicator body shown viewed from a channel side of the body.

FIG. 3 is a top view of the indicator body in FIG. 2.

FIG. 4 is a perspective view of the indicator body in FIGS. 2 and 3.

FIG. 5 is a top view of a rod coupler of the indicator assembly.

FIG. 6 is a perspective view of an indicator assembly kit according to the invention.

FIG. 7 is a side elevation view of the indicator assembly installed on the fishing rod with the indicator body shown in a casting or storage position.

FIG. 8 is a side elevation view of the indicator assembly installed on the fishing rod with the indicator body shown in a fishing position, after casting the fishing line.

FIG. 9 is a first representative diagram of the indicator assembly in a first fishing position, after the fisher has cast the line and as a fisher awaits a fish and a loop is created in the fishing line by the indicator body.

FIG. 10 is a second representative diagram of the indicator assembly in a second fishing position, as the fish takes the bait and hook and attempts to swim away. The indicator body is shown moving towards the fishing rod as tension in the fishing line is removed.

FIG. 11 is a third representative diagram of the indicator assembly shown in a third fishing position, where the indicator body is now affixed to the fishing rod as the fisher reels in the fish on the hook.

### DRAWINGS LIST OF REFERENCE NUMERALS

The following is a list of reference labels used in the drawings to label components of different embodiments of the invention, and the names of the indicated components.
10 indicator body
12 channel
14 indicator coupler
16 rod coupler
18 holder
20 tool
30 fishing rod
32 top tip or eyelet one or terminal eyelet
34a eyelet three
34b eyelet two
36 rod tip or tip
38 fishing line
40 fisher
42 hook
44 fish
46 bait
48 weight or sinker
50 reel
100 indicator assembly
110 indicator kit

### DETAILED DESCRIPTION

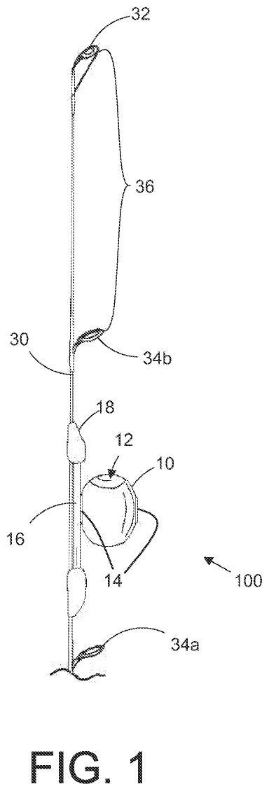

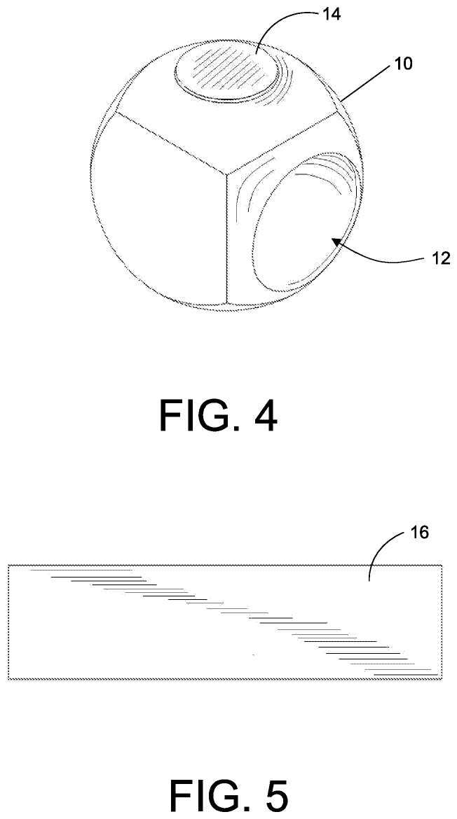

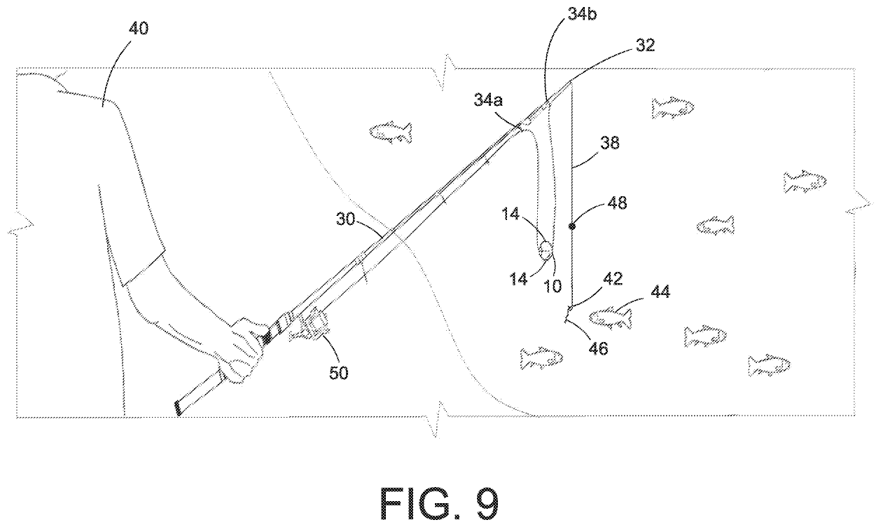

An indicator assembly 100 and indicator kit 110 according to the invention are shown in FIGS. 1-8, and a method of using the indicator assembly 100 is shown in FIGS. 9-11.

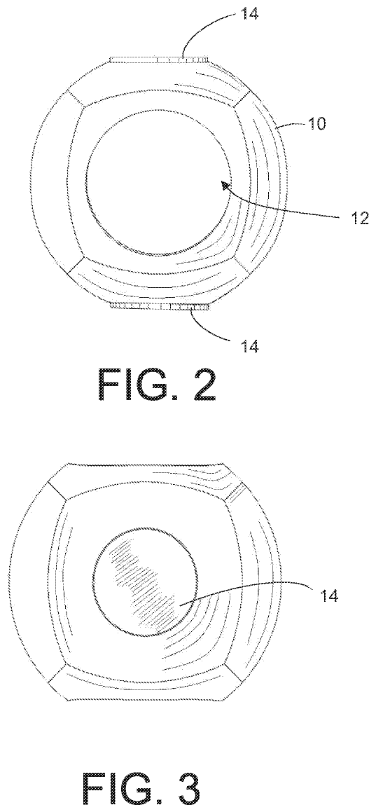

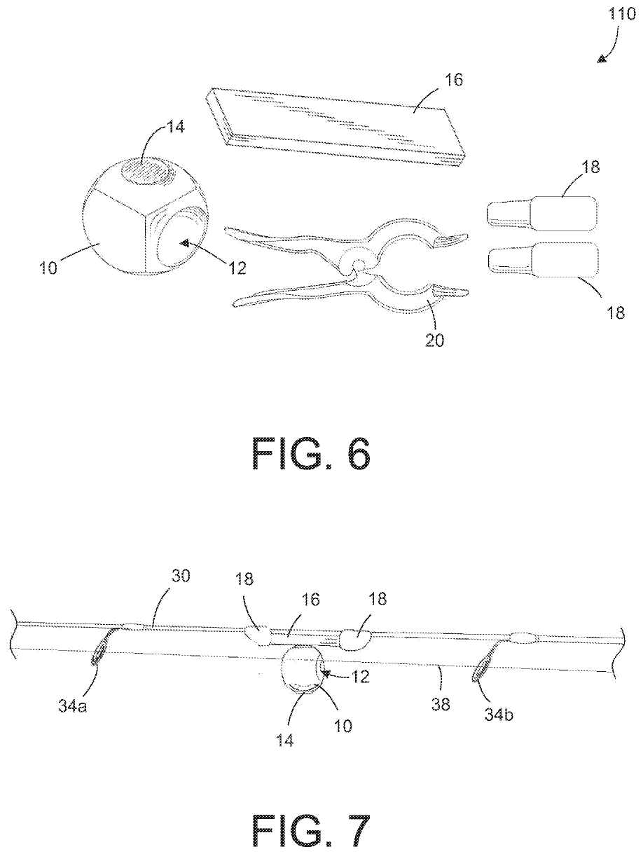

Turning to FIGS. 1-11, the indicator assembly 100 is comprised of an indicator body 10, a rod coupler 16 and a pair of holders 18. The indicator body 10 has an approximately spherical or cuboid shape with an exterior surface and a pair of opposed sides, each side fitted with an indicator coupler 14, as shown most clearly in FIG. 2. The indicator coupler 14 ideally has a flat outer face and can be recessed and flush with the indicator body 10, or partially raised above the indicator body 10 surface as shown in FIG. 2. The flat outer face of the indicator coupler 14 is required to maximize coupling with the rod coupler 16, which also has a flat outermost facing surface, as shown in FIGS. 5 and 6. While the indicator coupler 14 is shown configured as having a round or button shape, it may be configured as any other shape or as a plurality of couplers on a same face of the indicator body 10 so long as the indicator coupler 14 has sufficient surface area for coupling securely with the rod coupler 16.

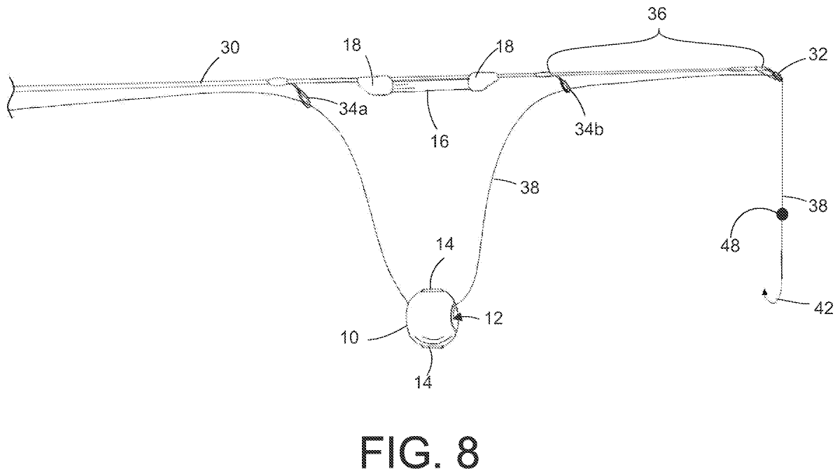

The indicator body 10 is further comprised of a through-hole or channel 12 formed through the indicator body 10 so as to be perpendicular to the indicator couplers 14. The channel 12 is sized at least a same size or larger than an eyelet three 34a and an eyelet two 34b of a fishing rod 30, and specifically, the channel 12 must be larger than each eyelet 34a 34b directly on either side of the installed indicator assembly 100 to ensure smooth casting by avoiding any constrictions or changes of tension in a fishing line 38 of the fishing rod 30. As shown in FIG. 7, when the indicator body 10 is coupled to the fishing rod 30 via coupling of the rod and indicator couplers 16 14, the fishing line 38 is taught and the indicator body 10 does not interfere or otherwise detour the fishing line 38 travel path between the eyelets 34a 34b. However, after casting, the indicator body 10 can be easily decoupled from the rod coupler 16 and allowed to hang below the fishing rod 30, creating a loop in the fishing line 38 to serve as the visual strike indicator as shown in FIG. 8.

The indicator body 10 can be made of plastic, wood, or other similar lightweight material. The material can also be capable of floating, in the event the indicator body 10 is dropped into the water and thus could be easily retrieved. The indicator body 10 can be made to glow in the dark using fluorescent materials or paints for day to evening fishing and can be configured to include physical bells or other simple physical auditory indicators that does not rely on electronics.

For the embodiment shown in the FIGS., the indicator body 10 is about ⅞ inches in diameter with a channel 12 having an approximately 0.5 inch diameter. Eyelet height on fishing rods vary even between different eyelets on a same fishing rod 30, where a height of the eyelet two 34b can range between 0.25 inches to a half inch, and a height of the eyelet three 34a can range between 0.5 to 0.75 inches. The inventor believes that the channel 12 diameter should ideally be no smaller than 0.5 inches and up to a maximum of about 1 inch, however notes that the indicator body 10 and channel 12 diameters are dependent on the eyelet size of the fishing rod 30 and as fishing rods have varying eyelet heights, the indicator body 10 and channel 12 are sized according to need. Thus if the height of the eyelets is 2 inches, the channel 12 will be sized so as to be at least 2 inches in diameter.

FIG. 6 shows the indicator assembly kit 110 having the pair of TPE flexible holders 18, a tool 20 for stretching each holder 18 to permit passage over a plurality of eyelets 34a 34b 32 and into an installation position, and the indicator body 10. The tool 20 and holders 18 are available from Nite Ize Inc. of Boulder, Colorado USA. Note that the holders 18 must be positioned on the fishing rod 30 prior to threading the fishing line 38 through the three eyelets at a tip 32 of the fishing rod

The holders 18 are positioned between eyelet two 34b and eyelet three 34a, that is, between the eyelets below the tip 36 of the fishing rod 30, with a terminal eyelet or tip top 32 of the fishing rod 30 serving as eyelet one for these purposes. The inventor notes that this position minimizes the number of eyelets the holders 18 otherwise must pass over, minimizing possible damage to the eyelets during installation and positioning the indicator assembly 100 in a location on the fishing rod 30 that is still convenient for a fisher 40 to reach and position the indicator body 10 away from the rod coupler 16 and still be far enough away from the fisher 40 to optimize the visual indicator properties of the indicator body 10. The indicator assembly 100 thus may otherwise be positioned in the tip 36 area of the fishing rod 30 or closer to a reel 50 of the fishing rod 30 as desired by the fisher 40. A very short fisher 40 may prefer the indicator assembly 100 be installed closer to the reel 50 for easier repositioning of the indicator body 10 after casting. The tool 20 shown in FIG. 6 is ideally made of plastic or other lightweight material and the design shown can be taken apart easily for storage. For a kit 110 sold without the tool 20, any pair of needle-nose pliers, particularly bent-nose needle-nose pliers can also easily be used to position the holders 18 onto the fishing rod 30, or by any other tool that can widen the holders 18 sufficiently to pass over the eyelets 34a 34b 32 and thus the inventor notes that the kit 110 could in fact just be comprised of the indicator assembly 100, and inclusion of the tool 20 is for convenience only and is not necessary for the kit 110. The holders 18 are ideally made of flexible and stretchy material, such as silicone, rubber or TPE (thermoplastic elastomeric materials) with sufficient stretch to secure the rod coupler 14 to the rod.

The rod and indicator couplers 16 14 shown in the FIGS. are rare earth magnets whose outer surfaces have opposite polarity to allow the indicator coupler 14 to be attracted to and securely affixed to the rod coupler 16. The inventor notes that casting results in considerable force on the fishing rod 30 and line 38, and rare earth magnets, being permanent magnets, are up to seven times stronger than ferrite magnets made of strontium carbonate and iron oxide and thus ideal for his invention. Ferrite magnets however may also be substituted for rare earth magnets, as can combinations of magnetic metal and magnets for the couplers 14 16. For instance, the rod coupler 16 could easily be a magnet and the indicator coupler 14 be a small disc of any magnetic metal, such as iron or cobalt, however the relative sizes of the magnet and magnetic metal may be larger than what is shown in the FIGS. to ensure the coupling is sufficiently strong to resist forces exerted during casting.

To use the indicator assembly 100, prior to fishing the fisher 40 uses the tool 20 or any other suitable tool to install the holders 18 and rod coupler 16 to the fishing rod 30 between eyelets two 34b and three 34a just below the tip 36 of the fishing rod 30. The indicator body 10 is then coupled to the rod coupler 16, as shown in FIG. 1. The fishing line 38 is then threaded through the eyelets of the fishing rod 30 and after threading the fishing line 38 through eyelet three 34a, the fishing line 38 is threaded through the channel 12 and then though eyelet two 34b and through the tip 32. As shown in FIG. 7, the channel 12 is sized sufficiently large to ensure the fishing line 38, when pulled taught, is a straight line and the indicator body 10 does not otherwise divert the fishing line 38 as this can create strain points on the fishing line 38 that may damage, weaken or break the fishing line resulting in loss of a hook 42 and thus a fish 44 on the hook 42. Once the fishing line 38 is threaded through the tip 32, the fisher 40 attaches the hook 42, bait 46, sinker 48 and any additional conventional bobbers or other indicators directly to the fishing line 38 after the tip 32, as desired. The inventor stresses that an advantage of his indicator assembly 100 over the prior art is the one-time installation of the assembly 100 onto the fishing rod 30 and that even when threading new fishing line 38 through the rod 30, the indicator assembly 100 remains in place and the indicator body 10 coupled to the rod coupler 16 is never loose, minimizing loss of the indicator body 10 and also simplifying threading the new fishing line 38. The inventor notes that without the rod coupler 16, an otherwise loose indicator body 10 would need to be threaded with fishing line 38 the way a pearl or other loose bead is threaded, and thus require one hand to hold the fishing rod 30, a second hand to hold the indicator body 10 and a third hand to hold and move an end of the fishing line 38 through the eyelets 34a 34b and indicator body 10. Hence, installation of the indicator assembly 100 without the rod coupler 16 and indicator coupler 14 is a two person job or requires the fisher 40 to use a rod holder or other device while threading the fishing line 38 through the indicator body 10 and eyelets 34a 34b. Thus, the rod and indicator couplers 16 14 when coupled create an extra “eyelet” for the fishing line 38 with minimal extra time required by the fisher 40 to accommodate the permanently installed indicator assembly 100.

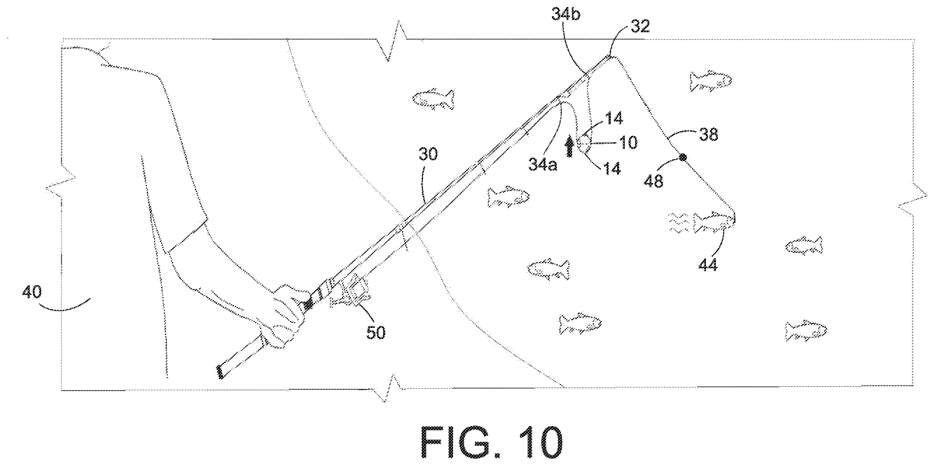

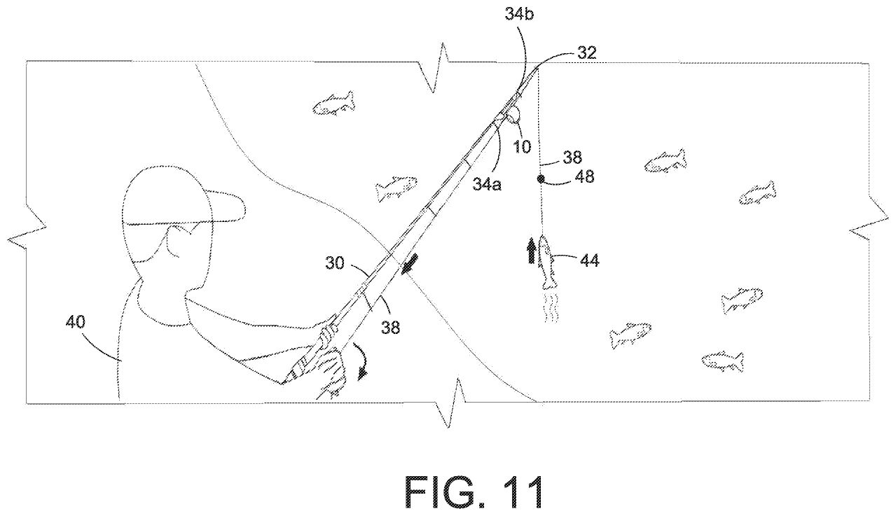

FIGS. 9-11 show the fisher 40, the fishing rod 30 and the indicator assembly 100 in a fishing position after casting has occurred. The fisher 40 is shown in a shore fishing position, however the inventor notes that his invention can be used equally well for boat fishing. In FIG. 9, the indicator body 10 is positioned in spaced apart relationship with the fishing rod 30, creating a loop in the fishing line 38. The loop shown in FIG. 9 can vary in length, according to the personal preferences of the fisher 40, and thus the loop size shown is for illustrative purposes only and is not meant to establish a specific loop size in order to practice the invention. In FIG. 10, the fish 44 has taken the bait 46 and is swimming away, pulling the fishing line 38 and reducing the loop size as the indicator body 10 moves upwards towards the fishing rod 30 and the rod coupler 16, signaling to the fisher 40 that the fish 44 has taken his hook 42 and bait 46. As tension in the fishing line 38 is increased by the fish 44 swimming away and/or the fisher reeling in the fishing line 38, the fishing line 38 becomes taught and the indicator body 10 locks itself to the fishing rod 30 by the indicator coupler 14 coupling to the rod coupler 16 as shown in FIG. 11. The fisher 40 reels in his fish 44, resets the bait 46 and casts again. Hence in each fishing cycle, the fisher 40 only has to adjust the indicator body 10 once, after casting his fishing line 38, simplifying the fishing process and eliminating much of the fussing involved with prior art strike indicators.

It is to be understood that the above-described arrangements are only illustrative of the application of the principles of the present invention. Numerous modifications and alternative arrangements may be devised by those skilled in the art without departing from the scope of the present invention. For instance, the indicator body 10 is shown as approximately spherical or cuboid and bead-like in appearance, however any body shape having a pair of opposed surfaces to which a coupler 14 can be securely affixed may be used, so long as the coupler 14 shape complements a shape of the rod coupler 16. The inventor believes that the couplers 14 16 shown in the FIGS. as having flat outer surfaces are simplest and most secure, however he can envision a more stylish design where the rod coupler 16 could be a pair of rounded peaks with a valley in between and the indicator coupler 14 could be configured as a rounded peak that fits into the valley of the rod coupler 16, or where the rod coupler 16 has a bowl shaped indentation into which the indicator coupler 14 has a rounded profile that secures into the bowl. As previously mentioned, the inventor prefers the use of rare earth magnets due to their strong magnetic forces and durability, however any magnetic metal materials can be used to practice his invention, provided that the indicator body 10 is sufficiently secured to the fishing rod 30 during casting. The inventor also notes that while the embodiment shown in the FIGS. shows a minimum of two couplers per indicator body, a single coupler could also be used that covers two or more sides of the body.

The inventor further notes that the channel 12 must be larger than the eyelets on either side of the indicator assembly 100 and recognizing that eyelet size varies on fishing rods 30, that several types of indicator bodies 10 may be created to accommodate different rods and their respective eyelet sizes.

Finally, the holders 18 shown in the FIGS. can be replaced with tape, clips, clamps or other suitable fasteners allowing the rod coupler 16 to be affixed securely to the fishing rod 30, and thus an embodiment of the kit 110 and indicator assembly 100 uses tape in lieu of the TPE material holders 18 illustrated in the FIGS. The inventor notes that there are many ways of affixing the rod coupler 16 to the fishing rod 30, including a simple C shaped clip affixed to the back of the rod coupler 16 and pressure fitted to the fishing rod 30. The inventor stresses that his indicator assembly 100 and kit 110 are not meant to be limited to just what is shown in the drawings, but rather the drawings show one particularly useful embodiment, with many possible variations that do not depart from the scope of the invention.

I claim:

1. A strike indicator assembly for use with a fishing rod having a terminal eyelet, a second eyelet and a third eyelet all in spaced apart relationship, and each eyelet having an eyelet height, the strike indicator comprising:
an indicator body having an exterior surface with two opposed sides in spaced apart relationship;
a channel having a channel diameter formed into the indicator body;
at least one indicator coupler having an outer face, the indicator coupler affixed to the exterior surface of one of the two opposed sides;
a rod coupler having a first end, an opposed second end, a back side and an opposed outermost surface sized and shaped to couple with the outer face of the indicator coupler; and
a holder fastening the rod coupler to the fishing rod;
wherein the rod coupler is at least one of a magnet or a magnetic metallic material;
wherein the indicator coupler is at least one of a magnet or magnetic metallic material;
wherein if the rod coupler and indicator coupler are both magnets, the rod coupler magnet has an opposite polarity to the indicator magnet; and
wherein if one of the rod coupler and the indicator coupler is a magnetic metallic material, the remaining coupler is a magnet.

2. The indicator assembly in claim 1, wherein the magnet is a rare earth magnet.

3. The indicator assembly in claim 1, wherein the indicator body is no more than about an inch in diameter and the channel is about half an inch in diameter.

4. The indicator assembly in claim 1, wherein the channel diameter is at least as large as the height of the third eyelet.

5. The indicator assembly in claim 1, wherein the outermost surface of the rod coupler and the outer face of the indicator coupler are both flat surfaces.

6. The indicator assembly in claim 1, wherein the indicator body is made at least in part of wood or plastic.

7. The indicator assembly in claim 1, wherein the indicator body floats on water.

8. The indicator assembly in claim 1, wherein the exterior surface is at least in part fluorescent.

9. The indicator body in claim 1, wherein the body approximates a sphere or a cuboid.

10. The holder in claim 1, wherein the holder is an elastic material selected from the group consisting of TPE, rubber, and silicone.

11. The holder in claim 1, wherein the holder is a pressure fitted clamp affixed to the back of the rod coupler and sized and shaped to fit onto the fishing rod.

12. An indicator assembly kit for a fishing rod having at least two eyelets and an eyelet height, comprising:
an indicator body having an exterior surface with at least one indicator coupler affixed thereto and with a channel formed through the indicator body;
a rod coupler having an outermost surface and a back side adapted to face against the fishing rod; and
at least one holder sized and shaped to affix the rod coupler to the fishing rod;
wherein the rod coupler is at least one of a magnet or a magnetic metallic material; and
wherein the indicator coupler is at least one of a magnet having an opposed polarity to that of the rod coupler or a magnet if the rod coupler is a magnetic metallic material.

13. The kit in claim 11, wherein the holder is an elastic material and further comprising a scissor-like tool for sufficiently stretching the holder to a diameter greater than that of the eyelet height, whereby the holder is stretched by the tool and then positioned onto the fishing rod.

14. The kit in claim 12, wherein the holder is one of a tape fastening material or pressure clamp.

15. A method of using an indicator assembly in claim 1, comprising the steps of:
attaching the indicator coupler to the rod coupler;
casting the fishing line;
decoupling the indicator coupler;
creating a loop in the fishing line wherein the indicator body is positioned at a lowermost point in the loop and is in spaced apart relationship with the fishing rod;
waiting for a fish to strike at the bait on the hook attached to the fishing line;
watching the indicator body rise towards the fishing rod and reattach to the rod coupler as the loop is eliminated from the fishing line by at least one of the striking fish swims away with the bait, a fisher reeling in the line, or both.

16. The method in claim 15, wherein the rod coupler is attached to the fishing rod between eyelet three and eyelet two, and further comprising the step of:
installing the rod coupler to the fishing rod,
prior to the step of attaching the indicator body to the fishing rod; and
further comprising the step of:
threading the fishing line through eyelet three;
threading the fishing line through the attached indicator body; and
threading the fishing line through eyelet two,
after the step of attaching the indicator body to the fishing rod.

17. The method in claim 16, further comprising the steps of:
determining an eyelet height of eyelet three of the fishing rod; and
selecting an indicator body having a channel diameter at least a same size as the eyelet height of eyelet three,
after the step of threading the fishing line through eyelet three and before the step of threading the fishing line through the indicator body.
